(19) United States
(12) Patent Application Publication
(10) Pub. No.: US 2007/0075854 A1
(43) Pub. Date: Apr. 5, 2007

(54) Motion activated home security system

(76) Inventor: Robert B. Tyler, Santa Maria, CA (US)

Correspondence Address: CHRISTOPHER D. HARRINGTON, SUITE 350, 5300 CORPORATE GROVE SE, GRAND RAPIDS, MI, 49512, US

(21) Appl. No.: 11/240,070

(22) Filed: Oct. 3, 2005

(51) Int. Cl. G08B 13/00

(52) U.S. Cl. 340/541

(57) ABSTRACT

A novel security system for use by a homeowner in protecting their premises, that is responsive to the presence of an intruder or others, the security system includes a housing for a motion detector, a recorder/playback system, a photo sensor, and a light display. In one embodiment, when the motion detector senses the presence of a person or an intruder it activates the photo sensor and the recorder/playback system, where the recorder/playback system will automatically play an outgoing message. If the event occurs during nighttime hours then the light display is simultaneously energized. The light display of the present invention includes a visual message, which may be symbolic or readable. The recorder/playback system may also allow an incoming message to be recorded by a person who is detected by the security system, the incoming message being kept for later playback by the homeowner.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to motion sensing security systems. More particularly, the present invention relates to a motion activated light and audible warning system.

Home security has been a concern for decades. Urban neighborhoods had the benefit of becoming lighted at night with the advent of electrical lighting systems. As electrical power distribution expanded from the urban, to the suburban and then finally to rural areas, it became the task of the individual homeowner to provide for lighted areas around the home. This was even more the case in rural areas where no street lighting was available at all.

The assurance that comes with lighted security is partially the deterrent value that is associated with having one's presence visible. In the 1990s, home lighting systems that employed motion detectors became very popular since they accomplished two benefits: they provided light directed towards a person within the zone of detection, and they also increased the attention towards a person being detected because of the sudden triggering of the light. Many of these systems included strong yard lights that cast a broad beam and provide serviceable lighting for purposes that the owner of the residence would find useful, i.e., ingress and egress to out buildings, attending to outside chores in the vicinity in the lighting system, among other events.

Variations of security and warning lighting have been known in the prior art. U.S. Reissue No. 36,930 (Houten, et al) teaches a lighted display for warning pedestrians of traffic conditions. The invention uses pictorial representations as part of the warning information. U.S. Pat. No. 5,729,924 (Reading) discloses an illuminated sign for imparting information to a person that is automatically activated at nightfall. U.S. Pat. No. 4,951,045 (Knapp, et al) teaches the use of an illuminated sign for imparting warning messages to a passerby, where the sign is activated by the presence of the person and which optionally includes an audible warning as well.

A warning and security lighting system that combines motion detection, audible warning, message imparting, and that is automatically activated by the photo detection of nighttime conditions has not been shown in the prior art. Nor has there been shown such a device that provides specific customized outgoing messaging, or the ability to record incoming messages. There has been a longstanding need for an advanced security device that enhances the ability to handle the imparting of specific messages and the recording of messages from persons entering protected property, as well as retaining the other features of security and lighting system. The benefits and attributes of the present invention in meeting these needs is shown and discussed herein.

### SUMMARY OF THE INVENTION

A novel home security system comprises a lighting and audible alarm system that includes motion detection for triggering the audible messages and photo detection for triggering the lighting system (in conjunction with the detection of the presence of a person with the motion detector) when the person is within the effective range of the security system. The audible warning includes a customized outgoing message for imparting specific information to a person within the effective range of the security system. The lighting includes the illumination of a readable and/or symbolic message for imparting information to a person within the effective range of the security system. The security system is powered by battery for stand-alone operation.

The home security system of the present invention also includes solar cells for the recharging of the battery during daylight.

The home security system of the present invention also includes the capability for the recording of a message from a person within the effective range of the security system.

### BRIEF DESCRIPTION OF THE DRAWINGS

FIG. 1 is an isometric view of the home security system of the present invention shown with the visual messages shown.

FIG. 2 is a cross sectional view of the home security system of the present invention as shown in FIG. 1 and taken along Section 2-2.

FIG. 3 is a flow chart showing the schematic operation of the home security system of the present invention where the lights are energized when the photo sensor detects nighttime conditions.

FIG. 4 is a flow chart showing the schematic operation of the home security system of the present invention where the lights are energized when the motion detector senses the presence of a person.

### DETAILED DESCRIPTION OF THE PREFERRED EMBODIMENTS

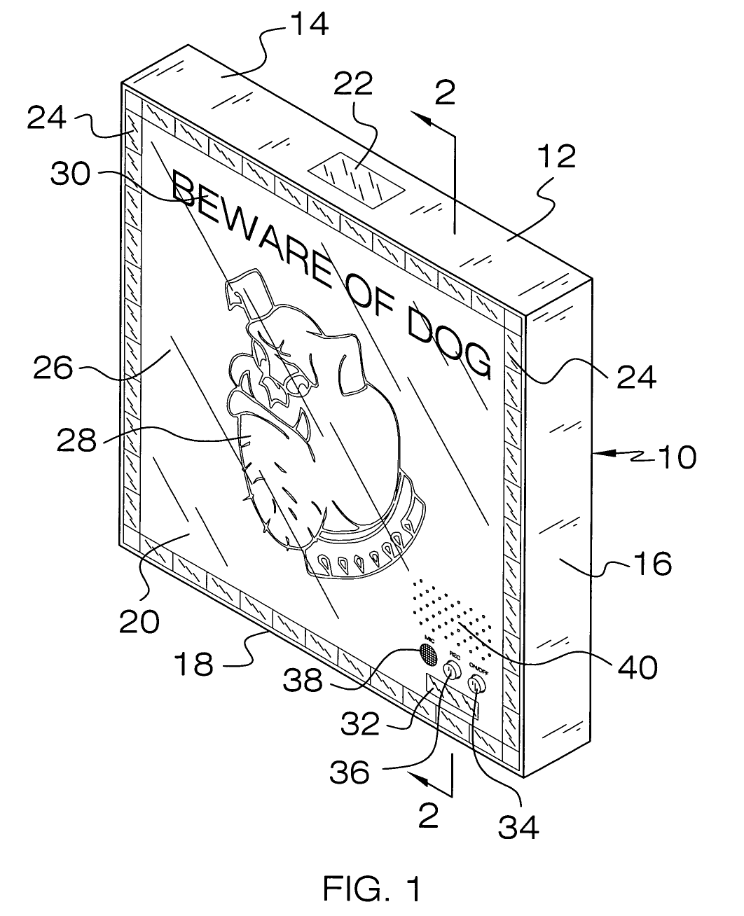

A novel home security system in accordance with the present invention is shown in the drawings. In FIG. 1, a security system 10 includes the housing 12, which includes the top 14, the side(s) 16, the bottom 18, and the front 20. Located on the top 14 of the housing 12 is the photo sensor 22. On the front 20 are the solar cells 24, is a light display that includes the translucent face 26, the symbolic design 28, and the readable message 30. Also included on the front of the unit is the motion detector 32, and the on/off switch 34. In addition, the record button 36, the microphone 38 and the speaker 40 can be seen all of which comprises parts of the recorder/playback portion 54.

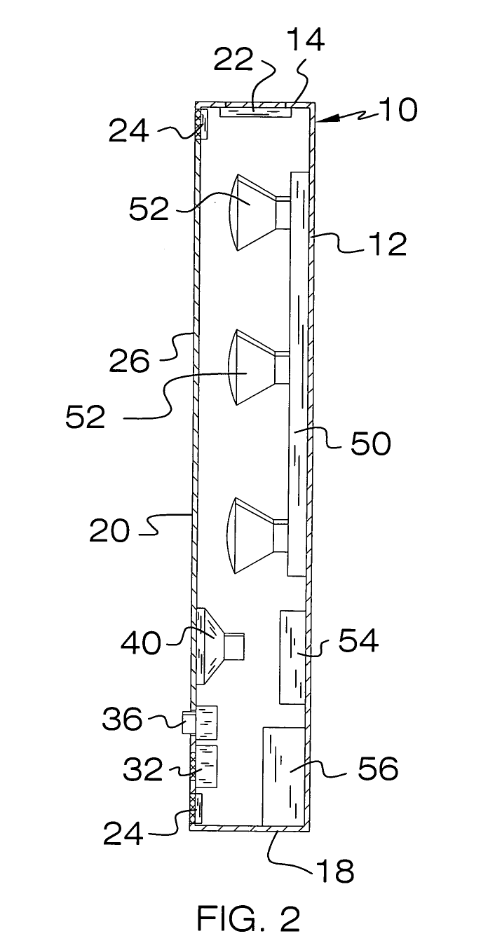

FIG. 2 shows the interior of the security system 10 of the present invention, with the circuit board 50, the lights 52, and the recording/playback portion 54 which includes the record button 36, the microphone 38 and the speaker 40. Also viewable is the power supply 56.

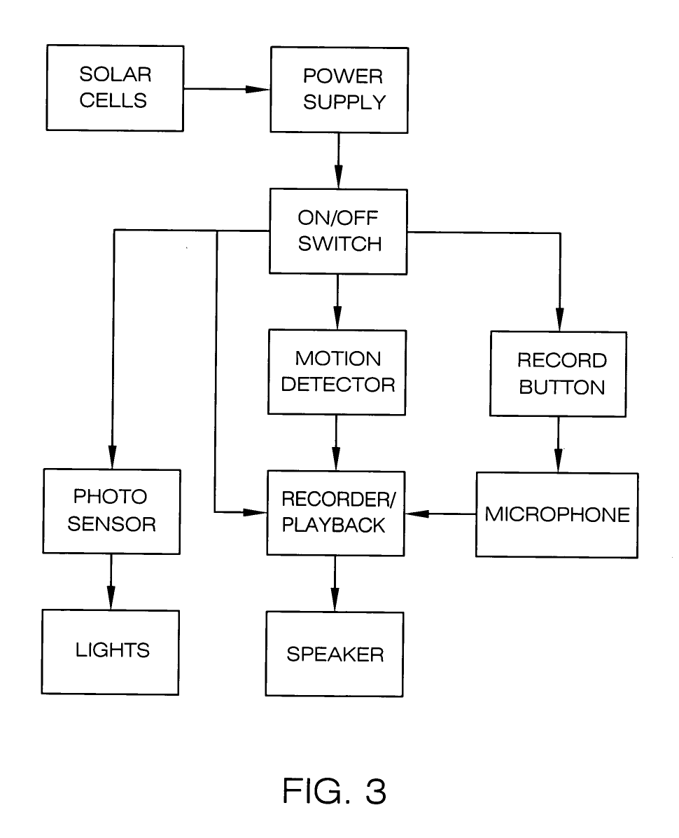

Turning now to FIG. 3, the operation of the first embodiment of the present invention is shown in schematic format. The power supply 56 is essentially the starting point, and it is preferentially comprised of a D.C. battery source. The solar cells 24 directly replenish the battery(ies) 56 during daylight hours. The security system is energized when the on/off switch 34 is turned on. In this embodiment, the photo sensor 22 is immediately energized and when nighttime conditions are detected the photo sensor 22 will then energize the lights 52 which will illuminate the translucent face 26 of the security system 10. The illumination will also reveal the symbolic design 28 and the readable message 30 that are on the translucent face 26.

The rest of the security system is energized as well, with the recording/playback portion 54 ready to operate based on the inputs it receives, the motion detector 32 being ready to send an input to the recorder/playback portion 54 if an intruder is detected, and the record button 36 and the microphone 38 being subject to operation if this is desired.

In use, the security system is turned on by the on/off switch 34. A message may be stored in the recorder/playback portion 54, whereby an audible warning may be given, such as “Beware of the dog!” Instructions may also be given, such as those that would be intended for a delivery person or a postal carrier, “Leave packages on the front porch.” The outgoing message can be modified as the user desires since it only requires the user to hit the record button 36 when initializing the security system. When a person is detected by the motion detector 32, the outgoing message is played through the speaker 40. This outgoing message can request the person to leave their own message on the security system, again, such as might be called for by a postal carrier who could state that he/she attempted to deliver a package and has returned it to the post office. To leave the message, the recorder/playback system can be programmed to allow for a set period of response even if the person/intruder does not cooperate, or it can instruct the person to use the record button 36 to activate a set period for recording an incoming message. The recorder/playback portion 54 would be programmed to receive a message for later retrieval by the user if the motion detector 32 had been tripped. Upon his/her return, the user could access the messages left by persons in this fashion and respond accordingly.

A benefit of the present invention is to provide a customized outgoing message in conjunction with symbolic and readable messages, all of which are intended to gain the attention of the person who is detected on the property. In severe cases, the messaging can be made appropriately stern, warning that the police will be called in 30 seconds if the person does not vacate the premises, or that the premises are guarded by a large dog, or any other statement that the user desires. The recorder/playback portion 54 of the security system typically has a digital recording section that allows the outgoing and the incoming messages to be kept and retrieved as needed.

When nighttime falls, the photo sensor 22 will energize the lights 52 which will illuminate the translucent face 26 as described above. The readable and symbolic messages will be readily visible and will help to prevent the unauthorized trespass on the user's property. The symbolic message 28 and the readable message 30 will help to reinforce the idea that the trespasser should stay away.

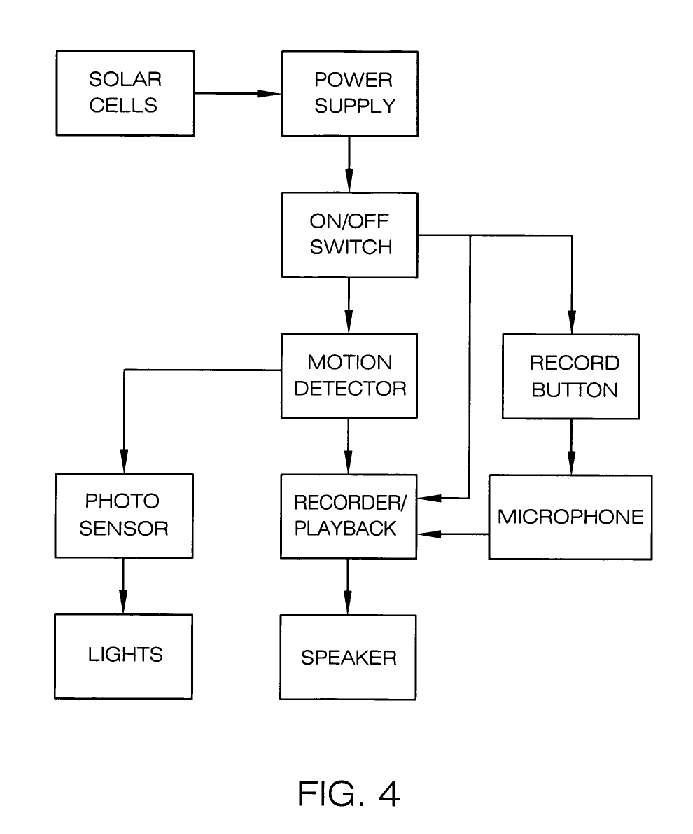

Turning now to FIG. 4, a second embodiment of the present invention is shown where the power supply 56 is channeled through the on/off switch 34 which energizes the motion detector 32, the recorder/playback portion 54 and the record button 36. In this embodiment, the photo sensor 22 will be energized by the motion detector 32 when and if the motion detector 32 senses the presence of an intruder. This means that if the detection of a person in the field sensed by the motion detector 32 during the nighttime hours, then the photo sensor 22 will then immediately energize the lights 52. The effect is that the potential intruder will be greeted by a lighted display and an audible warning when approaching this embodiment of the security system. The balance of the features of the present embodiment operate as was the case for the first embodiment discussed above.

The battery power for the present invention is augmented by the solar cells. The battery or batteries are preferably of the type that can be recharged in this fashion. The battery and solar cell arrangement is preferably calculated to be able to power the security system for the duration of the anticipated nighttime hours, although the demands on the battery and solar cells will vary depending on which embodiment of the present invention might be employed.

The housing for the security system is preferably fabricated from a plastic resin. Aside from the ease and low cost of manufacturing, the use of plastic in this instance would be compatible with extended outdoor exposure. The housing may also be used as suspended from the wall of a house, or a garage, or from a fence, or it may in the alternate, be supplied with a mounting for installation on a post or a stake. None of the potential mountings that might be considered for use with the enclosure are shown, however these are well known to one skilled in the art and may be employed as desired.

The security system is preferably designed for exterior use, outside the home or business of a user, although there is no reason that the security system couldn't be deployed inside a house, or an enclosed patio, or other such situation. The understanding is that the security system provides both the lighted and audible warnings/messages when the photo sensor detects a nighttime condition. Also, the use of the solar cells may be obviated if the security system is installed indoors, however in this instance the security system could be supplied with a power source that uses A.C. line current.

The usage of the outgoing message in the present invention may vary from providing a warning about the existence of a guard dog or some other form of security, or in some cases the user may desire to customize the outgoing message and to even ask for a response. Both embodiments are capable of recording an incoming message from a person who has been detected, which can be useful for people who are trying to deliver a package or stopping by to provide service. They can document their attempt by providing a voice message.

The foregoing teachings represent various ways in which the invention may be used. The teachings are not meant to be an exhaustive representation of all of the possible variations that the invention entails, but are meant to illustrate some of the possibilities for the purposes of instructing one as to the means for practicing the invention. Nothing herein should be viewed, therefore, as a limitation as to the potential scope of the invention.

I claim:

1. A security system responsive to the presence of a person or an intruder, mountable on the exterior of a homeowner's property and directed for use in detecting the presence of a person or intruder, the security system comprising;
A housing;
A motion detector for detecting a person or an intruder;
A recorder/playback portion capable of playing an outgoing message
A photo sensor for detecting nighttime conditions;
A light display;
A power supply for controllable energizing of the motion detector, the recorder/playback portion, the photo sensor and the light display; and,
Where the housing encloses the motion detector, the recorder/playback portion, the photo sensor, the light display and the power supply, and where upon the detection of a person or an intruder the recorder/playback portion is energized by the motion detector and the recorder/playback portion plays an outgoing message and where if the photo sensor senses nighttime conditions the photo sensor causes the light display to be energized.

2. The security system of claim number 1, where the recorder/playback portion further includes the capability of recording an incoming message.

3. The security system of claim number 1, where the power supply is a battery source.

4. The security system of claim number 3, where the security system further includes solar cells that are connected to the power supply for recharging said battery source.

5. The security system of claim number 1, where the light display is comprised of a readable message and a symbolic message.

6. The security system of claim number 1, where the security system may be mounted onto a post or a stake.

7. The security system of claim number 1, where the outgoing message is recordable by the homeowner.

8. A security system responsive to the presence of a person or an intruder, mountable on the exterior of a homeowner's property and directed for use in detecting the presence of a person or intruder, the security system comprising;
A housing;
A motion detector for detecting a person or an intruder;
A recorder/playback portion capable of playing an outgoing message
A photo sensor for detecting nighttime conditions;
A light display;
A power supply for controllable energizing of the motion detector, the recorder/playback portion, the photo sensor and the light display; and,
Where the housing encloses the motion detector, the recorder/playback portion, the photo sensor, the light display and the power supply, and where upon the detection of a person or an intruder the recorder/playback portion and the photo sensor are both energized by the motion detector upon detection of the person or intruder, and the recorder/playback portion plays an outgoing message and the photo sensor upon the sensing of the nighttime conditions energizes the light display.

9. The security system of claim number 8, where the recorder/playback portion further includes the capability of recording an incoming message.

10. The security system of claim number 8, where the power supply is a battery source.

11. The security system of claim number 10, where the security system further includes solar cells that are connected to the power supply for recharging said battery source.

12. The security system of claim number 8, where the light display is comprised of a readable message and a symbolic message.

13. The security system of claim number 8, where the security system may be mounted onto a post or a stake.

14. The security system of claim number 8, where the outgoing message is recordable by the homeowner.

15. A security system responsive to the presence of a person or an intruder, mountable on the exterior of a homeowner's property and directed for use in detecting the presence of a person or intruder, the security system comprising;
A housing;
A motion detector for detecting a person or an intruder;
A recorder/playback portion capable of playing an outgoing message and recording an incoming message.
A photo sensor for detecting nighttime conditions;
A light display comprised of a readable message and a symbolic message;
A power supply for controllable energizing of the motion detector, the recorder/playback portion, the photo sensor and the light display, where the power supply is a battery source;
Where the housing encloses the motion detector, the recorder/playback portion, the photo sensor, the light display and the power supply, and where upon the detection of a person or an intruder the recorder/playback portion and the photo sensor are both energized by the motion detector upon detection of the person or intruder, and the recorder/playback portion plays an outgoing message and the photo sensor upon the sensing of the nighttime conditions energizes the light display.

16. The security system of claim number 15, where the security system may be mounted onto a post or a stake.

17. The security system of claim number 15, where the security system further includes solar cells that are connected to the power supply for recharging said battery source.

18. The security system of claim number 15, where the outgoing message is recordable by the homeowner.
